(19) United States
(12) Patent Application Publication
(10) Pub. No.: US 2002/0007776 A1
(43) Pub. Date: Jan. 24, 2002

(54) Nursing bottle with color-change liquid temperature indication means

(76) Inventor: Rong-Long Wang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/899,253

(22) Filed: Jul. 6, 2001

(30) Foreign Application Priority Data
Jul. 19, 2000 (TW) 89212438

(51) Int. Cl. G01K 11/12

(52) U.S. Cl. 116/207; 116/216; 374/141

(57) ABSTRACT

A nursing bottle having a waterproof film adhered to the periphery, the waterproof film having a color-change temperature sensitive material that changes color subject to the variation of temperature of the liquid filled in the nursing bottle.

### BACKGROUND OF THE INVENTION

The present invention relates to a nursing bottle and, more particularly, to such a nursing bottle, which has means to indicate the temperature of the liquid filled therein.

When preparing milk with a nursing bottle for a baby, the mother or nurse does not know the actual temperature of the prepared milk. Touching the nursing bottle with the hand to test the temperature of prepared hot milk is less accurate. In order to accurately test the temperature of prepared hot milk, the mother or nurse may suck a small amount of prepared hot milk with the mouth, or squeeze a drop of prepared hot milk out of the nursing bottle to the skin of the arm. This temperature test procedure is inconvenient and nor hygienic. It is not good and may be harmful to the baby if the temperature of prepared milk is excessively hot or cold.

### SUMMARY OF THE INVENTION

The present invention has been accomplished to provide a nursing bottle, which eliminates the aforesaid problems. According to the present invention, a color-change temperature sensitive material is attached to the outside wall of the nursing bottle that changes color subject to the variation of temperature of the liquid filled in the nursing bottle, and an indication of color-temperature table is provided for reference.

### BRIEF DESCRIPTION OF THE DRAWINGS

FIG. 1 is an exploded view of a first embodiment of the present invention.

FIG. 2 is an exploded view of a second embodiment of the present invention.

### DETAILED DESCRIPTION OF THE PREFERRED EMBODIMENT

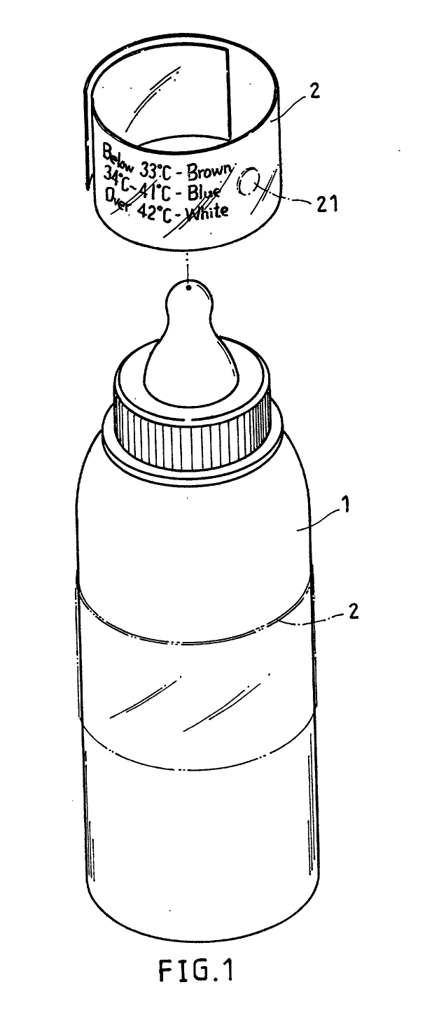

Referring to FIG. 1, a springy transparent plastic strip 2 is adhered to the periphery of a nursing bottle 1. The springy transparent plastic strip 2 is fixedly mounted with a spot of color-change temperature sensitive material 21 on the inner surface thereof. The color-change temperature sensitive material 21 changes its color subject to the variation of temperature of the liquid filled in the nursing bottle 1. Further, a color-temperature table is marked on the springy transparent plastic strip 2 adjacent to the color-change temperature sensitive material 21 for reference, for example, below 33° C.-brown; 34°˜41° C.-blue; over 42° C.-white.

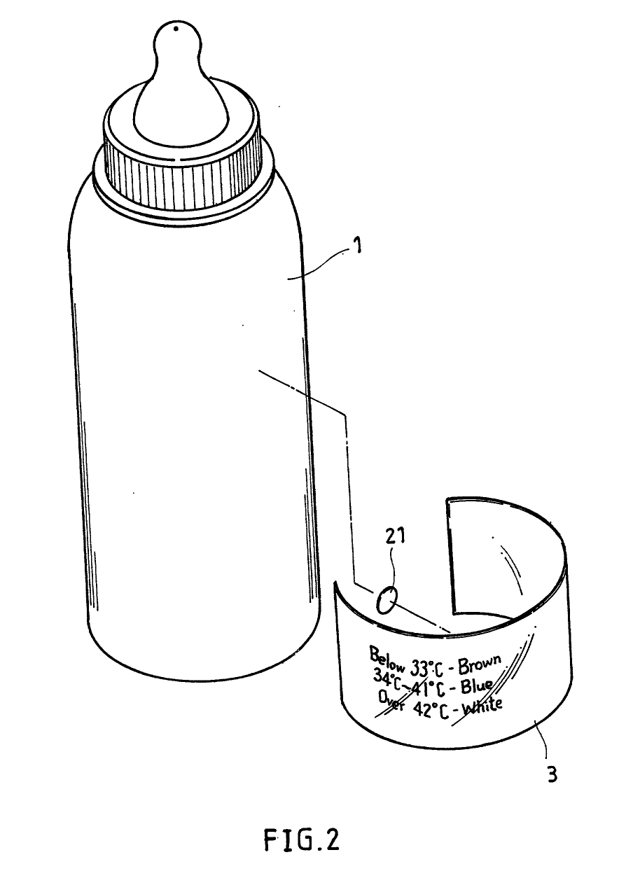

Referring to FIG. 2, a waterproof film 3 is adhered to the periphery of a nursing bottle 1. The waterproof film 3 is fixedly mounted with a spot of color-change temperature sensitive material 21 that change its color subject to the variation of temperature of the liquid filled in the nursing bottle 1. Further, a color-temperature table is marked on the springy transparent plastic strip 2 adjacent to the color-change temperature sensitive material 21 for reference.

A prototype of nursing bottle has been constructed with the features of FIGS. 1 and 2. The nursing bottle functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A nursing bottle comprising a sheet member adhered to the periphery thereof, a color-change temperature sensitive material fixedly fastened to an inner surface of said sheet member and adapted to change color subject to the variation of temperature of the liquid filled in the nursing bottle, and a color-temperature table marked on said sheet material adjacent to said color-change temperature sensitive material to indicate the variation of colors of said color-change temperature sensitive material corresponding to the change of temperature.

2. The nursing bottle of claim 1 wherein said sheet member is a springy transparent plastic strip.

3. The nursing bottle of claim 1 wherein said sheet member is a waterproof film.
